(19) United States
(12) Patent Application Publication
(10) Pub. No.: US 2006/0283059 A1
(43) Pub. Date: Dec. 21, 2006

(54) Bottle identifier

(76) Inventors: Virginia T. Cope, Vienna, VA (US); Robert A. Cope, Vienna, VA (US)

Correspondence Address: NIXON & VANDERHYE, PC, 901 NORTH GLEBE ROAD, 11TH FLOOR, ARLINGTON, VA, 22203, US

(21) Appl. No.: 11/155,619

(22) Filed: Jun. 20, 2005

(51) Int. Cl. G09F 3/00

(52) U.S. Cl. 40/310

(57) ABSTRACT

A bottle identifier includes a substantially circular, disk-shaped main body constructed of a resiliently flexible plastic material. The main body includes an outer peripheral edge, top and bottom substantially flat surfaces adapted to receive identifying indicia, a substantially circular opening defining an inner peripheral edge and adapted to receive the neck portion of the bottle, and a slit extending from the inner peripheral edge to the outer peripheral edge. The slit provides opposing end portions that are resiliently movable apart from another during attachment to and detachment from the neck portion of the bottle. The opening has a diameter that is smaller than a diameter of the flange of the bottle so that the main body may abut against the flange when the main body is removably attached to the neck portion of the bottle.

### FIELD OF THE INVENTION

The present invention relates to a bottle identifier for use in distinguishing a bottle from other similar bottles.

### BACKGROUND AND SUMMARY OF THE INVENTION

Although bottle identifiers that can be attached to a bottle to distinguish the bottle from other similar bottles have heretofor been known, they have not enjoyed widespread use. In part, such lack of commercial acceptance has been due to a lack of a bottle identifier design which readily indicates the owner of the bottle and thereby assists in preventing the spread of disease. The present invention provides improvements to known bottle identifiers.

One aspect of the invention relates to a bottle identifier including a compact, simple structure that is easily, removably attachable to a bottle and allows identifying insignia to be written and/or printed thereon.

Another aspect of the invention relates to a bottle identifier for use with a bottle including a base portion, a cap portion having an annular flange, and a tapered neck portion between the base portion and the cap portion. The bottle identifier includes a substantially circular, disk-shaped main body constructed of a resiliently flexible plastic material. The main body includes an outer peripheral edge, top and bottom substantially flat surfaces adapted to receive identifying indicia, a substantially circular opening defining an inner peripheral edge and adapted to receive the neck portion of the bottle, and a slit extending from the inner peripheral edge to the outer peripheral edge. The slit provides opposing end portions that are resiliently movable apart from another during attachment to and detachment from the neck portion of the bottle. The opening has a diameter that is smaller than a diameter of the flange of the bottle so that the main body may abut against the flange when the main body is removably attached to the neck portion of the bottle.

Other aspects, features, and advantages of this invention will become apparent from the following detailed description when taken in conjunction with the accompanying drawings, which are a part of this disclosure and which illustrate, by way of example, principles of the invention.

### BRIEF DESCRIPTION OF THE DRAWINGS

The accompanying drawings facilitate an understanding of the various embodiments of this invention. In such drawings:

FIG. 1 is a perspective view of a bottle identifier constructed according to an embodiment of the present invention, the bottle identifier removably attached to a bottle;

FIG. 2 is a top view of the bottle identifier shown in FIG. 1 removably attached to the bottle;

FIG. 3 is a plan view of the bottle identifier shown in FIG. 1 removed from the bottle;

FIG. 4 is a side view of the bottle identifier shown in FIG. 1 removed from the bottle;

FIG. 5 is a perspective view of the bottle identifier shown in FIG. 1 being removably attached to a bottle over the top thereof; and

FIG. 6 is a perspective view of the bottle identifier shown in FIG. 1 being removably attached to a bottle over the side thereof.

### DETAILED DESCRIPTION OF ILLUSTRATED EMBODIMENTS

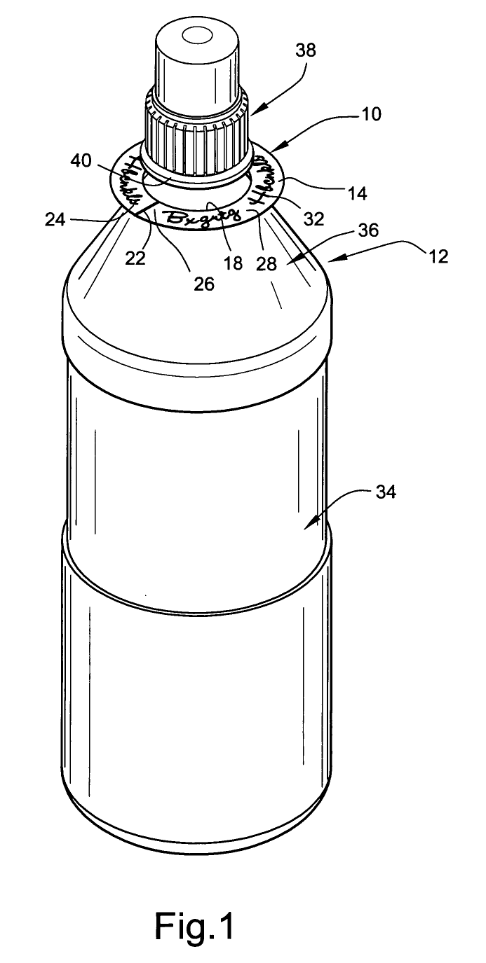

FIGS. 1-6 illustrate a bottle identifier 10 constructed according to an embodiment of the present invention. As described in greater detail below, the bottle identifier 10 is structured for use with a bottle 12, e.g., made of plastic, typically used to contain water, soda, sport drink, etc. The bottle identifier 10 is removably attachable to the bottle 12 to distinguish the bottle 12 from other similar bottles.

As best shown in FIGS. 3-4, the bottle identifier 10 includes a substantially circular, disk-like shape. As illustrated, the bottle identifier 10 includes a circular-shaped main body 14 that defines an outer peripheral edge 16. A circular-shaped opening 18 is provided in the main body 14 and defines an inner peripheral edge 20. Also, a slit 22 extends from the inner peripheral edge 20 to the outer peripheral edge 16. The slit 22 provides a negligible gap to allow opposing end portions 24, 26 of the main body 14 to be moved apart from another for attaching or detaching the bottle identifier 10 to the bottle 12.

The bottle identifier 10 is constructed from a non-toxic resiliently flexible plastic material, e.g., polyethylene, polypropylene, etc. The bottle identifier 10 may be cut into its desired shape in any suitable manner, e.g., stamped from a sheet of material.

The bottle identifier 10 may be provided in a variety of different colors. Moreover, the bottle identifier 10 provides top and bottom substantially flat surfaces 28, 30 (as illustrated in FIG. 4) that allows one or more identifying indicia 32 to be provided thereon (see FIG. 1). The identifying indicia 32 may be written and/or printed onto one or both of the surfaces 28, 30 by the user, e.g., with a pen. Alternatively, the identifying indicia 32 may be provided on one or both of the surfaces 28, 30 during manufacture.

FIG. 1 illustrates identifying indicia 32 provided on a surface 28 of the bottle identifier 10 to identify ownership of the bottle 12. As illustrated, the surface 28 on which the identifying indicia 32 is provided faces generally upwardly when the bottle identifier 10 is attached to the bottle 10 so it is easily visible. The identifying indicia 32 may take any suitable form including the user's name, the user's initials, numbers, corporate logos, fun designs, pictures, advertising, etc.

The bottle identifier 10 is adapted to be placed around a neck portion of a user's bottle 12 to allow the user to distinguish and easily identify his/her bottle 12 from other similar bottles. Moreover, the bottle identifier 10 is structured so that it is retained on the bottle 12 regardless of the orientation of the bottle 12.

As shown in FIGS. 1, 2, 5, and 6, known plastic bottles 12 have a similar construction including a base portion 34, a tapered neck portion 36, and a cap portion 38. As illustrated, the neck portion 36 is tapered so that the diameter of the neck portion 36 enlarges from the cap portion 38 towards the base portion 34. Also, the cap portion 38 includes an annular flange 40 that acts as a stop for the bottle cap of the cap portion 38.

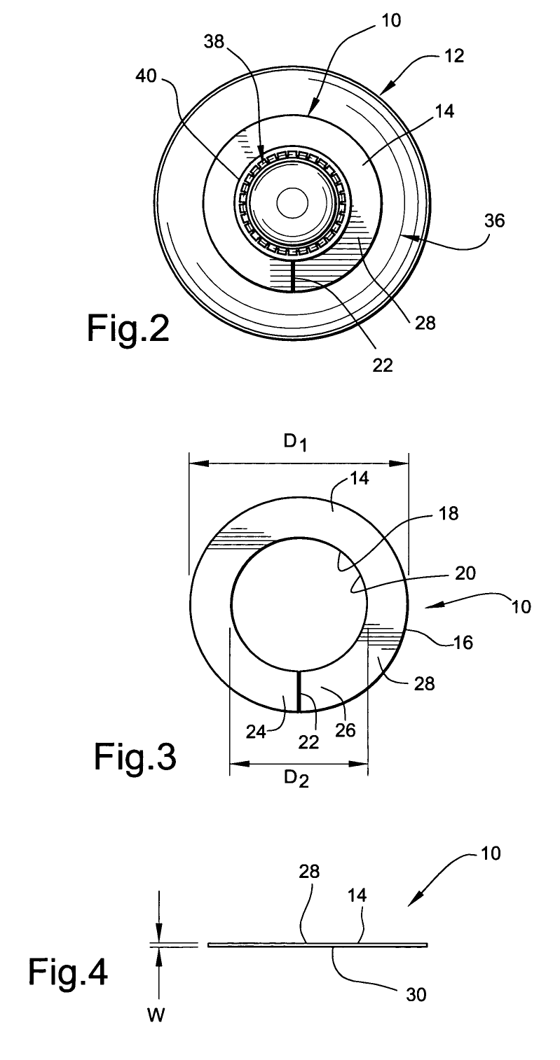

As best shown in FIGS. 1 and 2, the bottle identifier 10 is adapted to be seated on the neck portion 36 below the flange 40. The opening 18 of the bottle identifier 10 receives the neck portion 36 and is suitably dimensioned so that the main body 14 may abut against the flange 40 to prevent accidental removal of the bottle identifier 10 from the bottle 12.

Specifically, the opening 18 has a selected diameter that is larger than an upper region of the neck portion 36 near the cap portion 38 and smaller than a lower region of the neck portion 36 near the base portion 34. This arrangement allows the bottle identifier 10 to extend around the neck portion 36 and rest on a lower region of the neck portion 36. Also, the diameter of the opening 18 is selected so that it is smaller than a diameter of the flange 40 (see FIG. 2). This arrangement allows the main body 14 of the bottle identifier 10 to abut the flange 40 when the bottle identifier 10 is moved in the direction of the flange 40. Thus, the bottle identifier 10 is securely held in place and will not become easily detached upon various orientations of the bottle, e.g., when the bottle is titled or inverted.

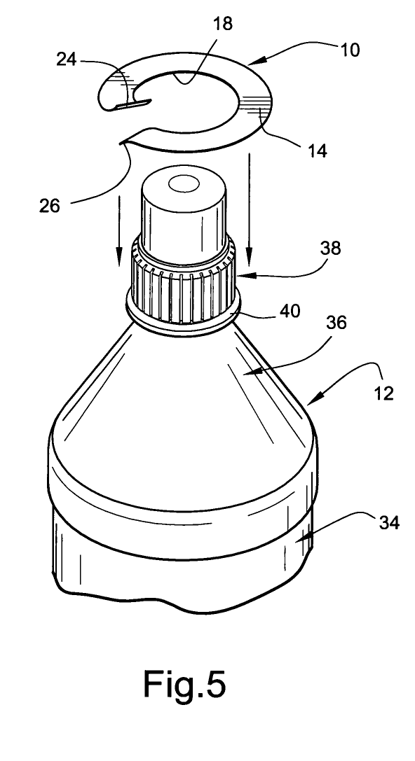

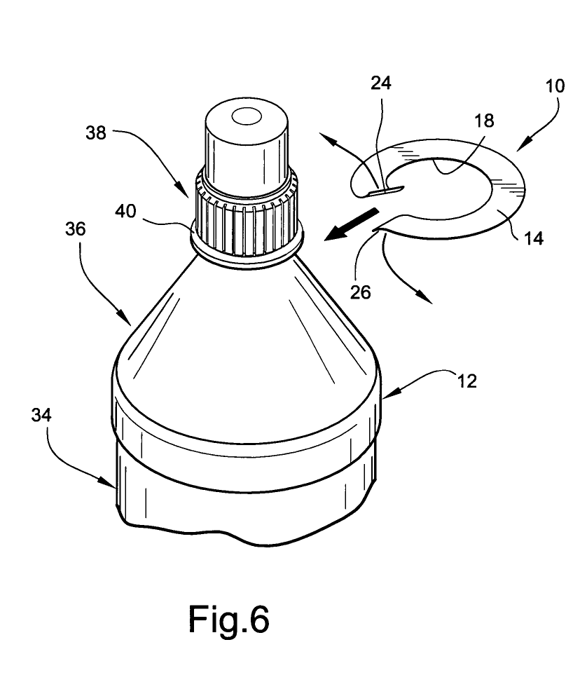

The slit 22 in the bottle identifier 10 allows easy attachment to and detachment from the bottle 12. The bottle identifier 10 may be attached and/or detached from the top of the bottle 12 (FIG. 5). Alternatively, the bottle identifier 10 may be attached and/or detached from a side of the bottle 12 (FIG. 6).

Specifically, the bottle identifier 10 is constructed from a flexible resilient material so that the opposing end portions 24, 26 will resiliently move back into its flat condition after being moved apart from one another during attachment or detachment. The bottle identifier 10 is structured such that the end portions 24, 26 can be moved vertically apart from one another and/or horizontally apart from another to widen the gap between the end portions 24, 26.

As shown in FIG. 5, when the bottle identifier 10 is attached from the top of the bottle 12, the end portions 24, 26 are moved apart from another to overcome the width of the flange 40. Then, the resilience of the bottle identifier 10 causes the end portions 24, 26 to move back into its flat condition so that the bottle identifier 10 is retained on the neck portion 36.

As shown in FIG. 6, when the bottle identifier 10 is attached from a side of the bottle 12, the end portions 24, 26 are moved apart from another to overcome the width of the upper region of the neck portion 36 near the cap portion 38. Then, the resilience of the bottle identifier 10 causes the end portions 24, 26 to move back into its flat condition so that the bottle identifier is retained on the neck portion 36.

In the illustrated embodiment, the axis of the bottle identifier 10 is generally aligned with the longitudinal axis of the bottle 12 when mounted thereto. Moreover, the bottle identifier 10 rests on the neck portion 36 so that the surfaces 28, 30 of the main body 14 extend in a plane that is generally transverse to the longitudinal axis of the bottle 12. However, the bottle identifier 10 may be suitably structured so that the surfaces 28, 30 may be inclined with respect to the longitudinal axis of the bottle 12 when mounted thereto.

When removal of the bottle identifier 10 from the bottle 12 is desired, the end portions 24, 26 can be moved apart from another to overcome the width of the neck portion 36, and then detached from the bottle 12. When detached, the bottle identifier 10 may be retained to be reused. Also, the identifying indicia 32 may be erasable so that the indicia 32 may be changed depending on user, application, etc.

In an embodiment, the main body 14 may have a diameter (D₁) of about 2-2.5 in., e.g., 2.25 in., the opening 18 may have a diameter (D₂) of about 1 in., and the width of the bottle identifier 10 may be about 0.03937 in. or about 1 mm., as shown in FIGS. 3-4. Although specific dimensions of an embodiment of the bottle identifier 10 are provided, it is to be understood that these dimensions are merely exemplary and other dimensions are possible depending on application, e.g., bottle size. That is, the dimensions of the bottle identifier 10 may be larger to accommodate a larger bottle. For example, in another embodiment, the main body 14 may have a diameter (D₁) of about 2.75 in., the opening 18 may have a diameter (D₂) of about 1.375 in., and the width of the bottle identifier 10 may be about 0.03937 in. or about 1 mm. In each embodiment of the bottle identifier 10, the diameter (D₁) may be larger to provide larger surfaces 28, 30 for identifying indicia 32.

Also, the shape of outer peripheral edge 16 may vary. In the illustrated embodiment, the outer peripheral edge 16 is circular-shaped. However, the outer peripheral edge 16 may have a non-circular shape, e.g., square or unique design.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A bottle identifier for use with a bottle including a base portion, a cap portion having an annular flange, and a tapered neck portion between the base portion and the cap portion, the bottle identifier comprising:
a substantially circular, disk-shaped main body constructed of a resiliently flexible plastic material,
the main body including an outer peripheral edge, top and bottom substantially flat surfaces adapted to receive identifying indicia, a substantially circular opening defining an inner peripheral edge and adapted to receive the neck portion of the bottle, and a slit extending from the inner peripheral edge to the outer peripheral edge,
the slit providing opposing end portions that are resiliently movable apart from another during attachment to and detachment from the neck portion of the bottle,
wherein the opening has a diameter that is smaller than a diameter of the flange of the bottle so that the main body may abut against the flange when the main body is removably attached to the neck portion of the bottle.

2. The bottle identifier according to claim 1, wherein the plastic material is one of polyethylene and polypropylene.

3. The bottle identifier according to claim 1, wherein the identifying indicia is manually written onto at least one of the top and bottom surfaces.

4. The bottle identifier according to claim 1, wherein the identifying indicia includes at least one of a user's name, a user's initials, numbers, corporate logo, unique design, pictures, and advertising.

5. The bottle identifier according to claim 1, wherein the main body is provided in a variety of different colors.

6. The bottle identifier according to claim 1, wherein the main body includes an axis that is aligned with an axis of the opening.

7. The bottle identifier according to claim 1, wherein the opening has a diameter of about 1 in.

8. The bottle identifier according to claim 7, wherein the main body has a diameter in the range of 2-2.5 in.

9. The bottle identifier according to claim 1, wherein the opening has a diameter of about 1.375 in.

10. The bottle identifier according to claim 9, wherein the main body has a diameter of about 2.75 in.

11. A method for distinguishing a bottle from other similar bottles, the method comprising:
providing a bottle identifier including a substantially circular, disk-shaped main body constructed of a resiliently flexible plastic material, the main body including an outer peripheral edge, top and bottom substantially flat surfaces, a substantially circular opening defining an inner peripheral edge, and a slit extending from the inner peripheral edge to the outer peripheral edge that provides opposing end portions that are resiliently movable apart from one another,
writing identifying indicia onto at least one of the top and bottom surfaces;
removably attaching the bottle identifier to the bottle by moving the end portions apart from another to overcome a neck portion of the bottle and allowing the resilience of the main body to cause the end portions to move back into its disk-shape so that the bottle identifier rests on the neck portion; and
selecting a diameter of the opening that is smaller than a diameter of a flange provided on a cap portion of the bottle so that the main body may abut against the flange when the bottle identifier is removably attached to the neck portion of the bottle.

12. The method according to claim 11, wherein writing identifying indicia includes writing at least one of a user's name, a user's initials, numbers, corporate logo, unique design, pictures, and advertising onto at least one of the top and bottom surfaces.
